(19) United States
(12) Patent Application Publication
(10) Pub. No.: US 2021/0325633 A1
(43) Pub. Date: Oct. 21, 2021

(54) IMAGING LENS AND IMAGING DEVICE

(71) Applicant: TAMRON CO., LTD., Saitama (JP)

(72) Inventor: Tomohiro KOBAYASHI, Saitama (JP)

(73) Assignee: TAMRON CO., LTD., Saitama (JP)

(21) Appl. No.: 17/093,872

(22) Filed: Nov. 10, 2020

(30) Foreign Application Priority Data
Apr. 16, 2020 (JP) 2020-073297

(51) Int. Cl. G02B 9/08; G02B 13/18; G02B 7/04

(52) U.S. Cl. CPC G02B 9/08; G02B 7/04; G02B 13/18

(57) ABSTRACT

An imaging lens is configured by, in order from an object side, an object side group including at least one lens group and having positive refractive power as a whole and an image side group configured by one lens group and having negative refractive power. Focusing is performed by moving the object side group in an optical axis direction, and a predetermined conditional expression is satisfied. The image side group includes a subgroup satisfying a predetermined conditional expression. Further, an imaging device includes the optical system and an image sensor.

### CROSS-REFERENCE TO RELATED APPLICATIONS

This application is based on and claims the benefit of priority from Japanese Patent Application No. 2020-073297, filed on Apr. 16, 2020, the entire contents of which are incorporated herein by reference.

### BACKGROUND OF THE INVENTION

### Technical Field

The present invention relates to an imaging lens and an imaging device, and more particularly to an optical system suitable for an imaging device using a solid-state image sensor (a (CD, a CMOS, and the like) such as a digital still camera or a digital video camera and an imaging device.

### Related Art

In the related art, an imaging device has become widespread which uses various solid-state image sensors such as a video camera, a digital still camera, a single lens reflex camera, and a mirrorless camera. With the progress of miniaturization of these imaging devices, further miniaturization of the imaging lens (optical system) thereof is required, and a macro lens is no exception. The macro lens generally refers to an imaging lens having a maximum imaging magnification of 0.5 to one time, and some have a maximum imaging magnification of one time to or more. The macro lens has a shorter shortest imaging distance than other lenses such as a zoom lens, and can capture an image from infinity to a short-distance subject and can express an image differently from other lenses.

As such a macro lens, for example, Japanese Patent No. 5629389 proposes an imaging lens which is configured by a first lens group and a second lens group having positive refractive power and arranged in order from an object side to an image side and performs focusing by moving the first lens group to the object side.

JP 2019-144441 A proposes an imaging lens which is configured by a first lens group having positive refractive power, a second lens group having positive refractive power, and a third lens group having negative refractive power in order from the object side to the image side and performs focusing by moving the first lens group and the second lens group to the object side with different trajectories.

These macro lenses are intended to suppress aberration fluctuations during focusing, for example, spherical aberration and fluctuations in curvature of image plane and to realize high optical performance over the entire focus range.

However, in the imaging lens disclosed in Japanese Patent No, 5629389, the refractive power of the first lens group for focusing is weak, and thus, the amount of movement during focusing is large with respect to the total optical length, which is not sufficient in terms of miniaturization. Further, the maximum imaging magnification of the imaging lens is 0.5 times, and a macro lens is required which has a higher maximum imaging magnification.

The maximum imaging magnification of the imaging lens disclosed in JP 2019-144441 A is one time, which is excellent in this term. On the other hand, in the imaging lens, the refractive power of the lens arranged on the image side is weaker than that of the lens group which moves on an optical axis during focusing, and the aberration occurring during focusing cannot be corrected satisfactorily, which is not sufficient in terms of the improvement of performance.

In these imaging lenses, reduction in cost is also required in addition to the performance improvement and the miniaturization.

In this regard, an object of the present invention is to provide an imaging lens capable of imaging close to a subject and an imaging device which have high optical performance while achieving miniaturization and cost reduction.

### SUMMARY OF THE INVENTION

In order to solve the above problems, an imaging lens according to the present invention is configured by, in order from an object side, an object side group including at least one lens group and having positive refractive power as a whole and an image side group configured by one lens group and having negative refractive power. Focusing is performed by moving the object side group in an optical axis direction, and a following conditional expression (1) is satisfied. The image side group includes a subgroup 2p satisfying a following conditional expression (2) and having positive refractive power.

0<f1/f<0.75 (1)

0<f2p/f<0.5 (2)
where
f is a focal length of the imaging lens during infinity focusing,
f1 is a focal length of the object side group, and
f2p is a focal length of the subgroup 2p.

Further, in order to solve the above problems, an imaging device according to the present invention includes the above-described imaging lens and an image sensor which converts an optical image formed by the imaging lens into an electrical signal.

According to the present invention, it is possible to provide the imaging lens capable of imaging close to a subject and the imaging device which have high optical performance while achieving miniaturization and cost reduction.

### BRIEF DESCRIPTION OF THE DRAWINGS

FIG. 1 is a cross-sectional view (upper row) of an imaging lens according to a first embodiment of the present invention during infinity focusing and a cross-sectional view (lower row) of the lens during focusing on a short-distance subject;

FIG. 2 is a spherical aberration diagram, an astigmatism diagram, and a distortion aberration diagram of the imaging lens of the first embodiment during the infinity focusing;

FIG. 3 is a spherical aberration diagram, an astigmatism diagram, and a distortion aberration diagram of the imaging lens of the first embodiment during focusing on the short-distance subject;

FIG. 4 is a cross-sectional view (upper row) of an imaging lens according to a second embodiment of the present invention during infinity focusing and a cross-sectional view (lower row) of the lens during focusing on a short-distance subject;

FIG. 5 is a spherical aberration diagram, an astigmatism diagram, and a distortion aberration diagram of the imaging lens of the second embodiment during the infinity focusing;

FIG. 6 is a spherical aberration diagram, an astigmatism diagram, and a distortion aberration diagram of the imaging lens of the second embodiment during focusing on the short-distance subject;

FIG. 7 is a cross-sectional view (upper row) of an imaging lens according to a third embodiment of the present invention during infinity focusing and a cross-sectional view (lower row) of the lens during focusing on a short distance subject;

FIG. 8 is a spherical aberration diagram, an astigmatism diagram, and a distortion aberration diagram of the imaging lens of the third embodiment during the infinity focusing;

FIG. 9 is a spherical aberration diagram, an astigmatism diagram, and a distortion aberration diagram of the imaging lens of the third embodiment during focusing on the short-distance subject;

FIG. 10 is a cross-sectional view (upper row) of an imaging lens according to a fourth embodiment of the present invention during infinity focusing and a cross-sectional view (lower row) of the lens during focusing on a short-distance subject;

FIG. 11 is a spherical aberration diagram, an astigmatism diagram, and a distortion aberration diagram of the imaging lens of the fourth embodiment during the infinity focusing;

FIG. 12 is a spherical aberration diagram, an astigmatism diagram, and a distortion aberration diagram of the imaging lens of the fourth embodiment during focusing on the short-distance subject;

FIG. 13 is a cross-sectional view (upper row) of an imaging lens according to a fifth embodiment of the present invention during infinity focusing and a cross-sectional view (lower row) of the lens during focusing on a short-distance subject;

FIG. 14 is a spherical aberration diagram, an astigmatism diagram, and a distortion aberration diagram of the imaging lens of the fifth embodiment during the infinity focusing; and

FIG. 15 is a spherical aberration diagram, an astigmatism diagram, and a distortion aberration diagram of the imaging lens of the fifth embodiment during focusing on the short-distance subject.

### DESCRIPTION OF THE EMBODIMENTS

Hereinafter, embodiments of an imaging lens and an imaging device according to the present invention will be described. However, an imaging lens and an imaging device described below are one aspect of the imaging lens and the imaging device according to the present invention, and the imaging lens and the imaging device according to the present invention are not limited to the following aspects.

1. Imaging Lens

### 1-1. Optical Configuration.

The imaging lens is configured by an object side group having positive refractive power and an image side Group having negative refractive power in order from an object side and performs focusing by moving the object side group in an optical axis direction. With the above-described refractive power arrangement, the subject image formed by the object side group is magnified by the image side group. Therefore, it is possible to capture an image close to the subject, and further, it is possible to reduce the amount of extension of the object side group during focusing. As described above, the imaging lens has a configuration suitable for a macro lens capable of photographing from infinity to a short distance, and for example, the entire image can be made compact while achieving a maximum imaging magnification of 0.5 times or more. Hereinafter, the configuration of each lens group will be described.

Here, in the imaging lens, the “lens group” refers to a group configured by one or a plurality of lenses arranged adjacent to each other, the object side group is configured by one or a plurality of lens groups, and the image side group is configured by one lens group. Further, it is assumed that the air spacing of the lens groups adjacent to each other changes during focusing. Further, when referred to as “one lens group”, the air spacing of each lens included in the “one lens group” is not changed during focusing.

(1) Object Side Group

The object side group is a lens group which moves in the optical axis direction during focusing, and in the imaging lens, the object side group includes all lens groups arranged on the object side from the image side group.

As long as the object side group includes at least one lens group and has positive refractive power as a whole, the specific lens group configuration and lens configuration are not particularly limited Further, from the following viewpoints, it is preferable that the object side group has an aperture stop, and it is preferable that a configuration is made such that the object side and the image side of the aperture stop have excellent symmetry with the aperture stop interposed therebetween.

In the imaging lens, the subject image formed by the object side group as described above is magnified by the image side group. At that time, various aberrations are also magnified. Therefore, in order to achieve good imaging performance, it is necessary to reduce the aberration occurring in the object side group. Therefore, by arranging the aperture stop in the object side group and moving the aperture stop integrally with the object side group in the optical axis direction during focusing, it is possible to suppress the fluctuation of aberration and the fluctuation of the peripheral illumination ratio during focusing. At this time, it is preferable that a configuration is made such that the object side and the image side of the aperture stop have a concave surface with the aperture stop interposed therebetween and have excellent symmetry, that is, a double gauss type configuration is made. By arranging the aperture stop in the object side group and forming a double gauss type configuration with the aperture stop interposed therebetween, it is possible to satisfactorily correct various aberrations occurring off-axis while correcting spherical aberration.

It is preferable to have at least one negative lens on the object side from the aperture stop in the object side group. In this case, spherical aberration can be corrected more satisfactorily.

Further, it is preferable that the object side group is configured by seven or less lenses. As a result, it is possible to reduce the size and weight while reducing the cost. On the other hand, when the number of lenses configuring the object side group is small, it becomes difficult to perform aberration correction and the like satisfactorily. Therefore, it is preferable that the object side group is configured by four or more lenses. For example, when configured by four lenses, it is preferable that the positive lens, the negative lens, the aperture stop, the negative lens, and the positive lens are arranged in this order from the object side.

(2) Image Side Group

The image side group is a lens group arranged closest to the image side in the imaging lens and has negative refractive power. The image side group has negative refractive power as a whole and has a subgroup 2p having positive refractive power as described below. The specific lens configuration of the image side group is not particularly limited except that the image side group is configured by one lens group. Incidentally, the subgroup 2p is not the lens group described above but a part of the image side group.

The subgroup 2p has positive refractive power as described above and thus includes at least one positive lens. By arranging the subgroup 2p having positive refractive power in the image side group having negative refractive power, it becomes possible to satisfactorily correct aberrations of the curvature of image plane or the like. It is preferable that the subgroup 2p is configured by two or less lens elements. Further, it is more preferable that the subgroup 2p is configured by a single lens element. Here, the single lens element means an element configured by only one lens or only one cemented lens in which a plurality of lenses are cemented. By configuring the subgroup 2p with a single lens element, it becomes easy to obtain an imaging lens with high optical performance while reducing the size and weight of the image side group.

It is more preferable that a lens having negative refractive power is arranged closest to the object side of the image side group. With such a configuration, the fluctuations in curvature of image plane occurring during focusing can be corrected satisfactorily, and it becomes easy to obtain an imaging lens with nigh optical performance.

It is more preferable that the image side group includes a subgroup 2n having negative refractive power. That is, it is preferable that the image side group includes the subgroup 2n and the subgroup 2p in order from the object side. By providing the subgroup 2n, the maximum height of the light beam incident on the subgroup 2p becomes high, so that the aberration can be corrected more satisfactorily in the subgroup 2p, and an imaging lens with high optical performance can be obtained more easily.

It is more preferable that the image side group includes a subgroup 2nb having negative refractive power on the most image side. At this time, it is preferable that the subgroup 2nb is arranged adjacent to the image side of the subgroup 2p. By providing the subgroup 2nb, it becomes easier to correct the curvature of image plane satisfactorily and obtain an imaging lens with high optical performance.

### 1-2. Operation

In the imaging lens, the object side group moves in the optical axis direction when focusing from infinity to a close subject. In a case where the object side group is configured by one lens group, the object side group moves in a predetermined trajectory as one focus group. In a case where the object side group is configured by a plurality of lens groups (for example, a first A lens group and a first B lens group), each lens Group may be moved along a different trajectory in the optical axis direction. In this case, focusing is performed by the so-called floating focus method, and thus becomes easy to suppress aberration fluctuations during focusing and realize high optical performance in the entire focusing range. On the other hand, when the entire object side group is focused as one focus group on the subject, it is possible to simplify the mechanical mechanism for moving the focus group in the optical axis direction and to reduce the imaging lens in size, weight, and cost.

The image side group may be moved along a trajectory different from that of the object side group in the optical axis direction during focusing. However, also in this case, the object side group and the image side group are necessarily moved along different trajectories in the optical axis direction, which leads to complication of the mechanical structure for moving the groups. Therefore, it is preferable that the image side group is fixed to the image plane during focusing. By setting the image side group as a fixed group, it is possible to reduce the imaging lens in size, weight, and cost.

### 1-2. Conditional Expression

Hereinafter, various conditional expressions which the imaging lens preferably satisfies will be described.

### 1-2-1. Conditional Expression (1)

0<f1/f<0.75 (1)
where
f is a focal length of the imaging lens during infinity focusing, and
f1 is a focal length of the object side group.

The conditional expression (1) is an expression that defines the ratio between the focal length of the imaging lens and the focal length of the object side group during infinity focusing. By satisfying the conditional expression (1), the refractive power of the object side group can be within an appropriate range, and the amount of movement of the object side group during focusing can be within an appropriate range. As a result, it is possible to realize an imaging lens with high optical performance, suppress an increase in the total optical length, and reduce the size of the imaging lens.

On the other hand, when the value of the conditional expression (1) exceeds an upper limit value, the amount of movement of the object side group during focusing is increased. As a result, the total optical length is increased. Therefore, it is not preferable for reducing the size of the imaging lens.

In order to obtain the above effect, the upper limit value of the conditional expression (1) is more preferably 0.7, further preferably 0.6, and even more preferably 0.5. Incidentally, in a case where these preferable lower limit values or upper limit values are adopted, the inequality sign. (<) may be replaced with the equal sign inequality sign (≤) in the conditional expression (1). The same applies to other conditional expressions in principle.

1-2-2. Conditional Expression (2)

0<f2p/f<0.5 (2)
where
f2p: is a focal length of the subgroup 2p.

The conditional expression (2) is an expression that defines the ratio between the focal length of the subgroup 2p and the focal length of the imaging lens. When the positive refractive power arranged in the object side group is increased in order to set the maximum imaging magnification of the imaging lens to 0.5 or more, it is necessary to increase the negative refractive power arranged in the image side group. When the negative refractive power arranged in the image side group is increased, the curvature of image plane tends to be overcorrected.

However, by arranging the subgroup 2p satisfying the conditional expression in the image side group, it becomes possible to correct the curvature of image plane by the subgroup 2p, and it is possible to realize an imaging lens with high optical performance.

On the other hand, when the value of the conditional expression (2) exceeds the upper limit value, the refractive power of the subgroup 2p is weakened. When the positive refractive power arranged in the object side group and the negative refractive power arranged in the image side group are increased, it becomes difficult to satisfactorily correct the curvature of image plane, and it becomes difficult to realize an imaging lens with high optical performance. Therefore, in order to realize an imaging lens with high optical performance, it is necessary to weaken the refractive power arranged in the object side group and the image side group, and in that case, it becomes difficult to reduce the size of the imaging lens.

In order to obtain these effects, the upper limit value of the conditional expression (2) is more preferably 0.45, further preferably 0.40, and even more preferably 0.35.

1-2-3. Conditional Expression (3)

|β|≥0.5 (3)
where
   |β‥ is a paraxial imaging magnification of the imaging lens at the shortest imaging distance.

The conditional expression (3) is an expression that defines the paraxial imaging magnification of the imaging lens at the shortest imaging distance. By satisfying the conditional expression (3), the imaging lens can image the subject at the maximum imaging magnification of 0.5 times or more.

The lower limit value of the conditional expression (3) is more preferably 0.6, further preferably 0.8, and even more preferably 1.0.

1-2-4. Conditional Expression (4)

0<Bf1/f<0.4 (4)
where
Bf1 is a distance on the optical axis from the most image side surface of the object side group to the focal position of the on side group.

The conditional expression (4) is an expression that defines the ratio between the focal length of the imaging lens during infinity focusing and the distance on the optical axis from most image side surface of the object side group to the focal position of the object side group. By satisfying the conditional expression (4), it becomes easy to shorten the total optical length of the imaging lens during infinity focusing, which is preferable in order to reduce the size of the imaging lens.

On the other hand, when the value of the conditional expression (4) exceeds the upper limit value, it becomes difficult to shorten the total optical length of the imaging lens during infinity focusing, and it becomes difficult to reduce the size of the imaging lens.

Here, in order to obtain the above effect, the upper limit value of the conditional expression (4) is more preferably 0.35, further preferably 0.3, and even more preferably 0.25.

1-2-5. Conditional Expression (5)

0.3≤BF/Y≤1.7 (5)
where
BF is a back focus of the imaging lens during infinity focusing, and
Y is a maximum image height of the imaging lens.

The conditional expression (5) is an expression that defines the ratio between the back focus of the imaging lens during infinity focusing and the maximum image height of the imaging lens. In a case where a lens group having negative refractive power is arranged on the image side of the imaging lens, when a light beam is obliquely incident on the on-chip microlens provided on the imaging surface, so-called shading may occur, and limb darkening (shading) may occur. By satisfying the above conditional expression (5), it is possible to prevent shading from occurring, and it is possible to suppress an increase in the total optical length of the imaging lens.

On the other hand, when the value of the conditional expression (5) is less than the lower limit value, the back focus becomes too short, and it may be difficult to suppress shading. Further, when the value of the conditional expression (5) exceeds the upper limit value, the back focus is lengthened, and the total optical length becomes long, so that it becomes difficult to reduce the size of the imaging lens.

In order to obtain these effects, the lower limit value of the conditional expression (5) is more preferably 0.4, further preferably 0.5, and even more preferably 0.6. Further, the upper limit value of the conditional expression (5) is more preferably 1.4, further preferably 1.3, and even more preferably 1.2.

1-2-6. Conditional Expression (6)

TL/f≤1.2 (6)
where
TL is a total optical length of the imaging lens during infinity focusing.

The conditional expression (6) is an expression that defines the ratio between the total optical length of the imaging lens during infinity focusing and the focal length of the imaging lens. By satisfying the conditional expression (6), it is possible to realise a compact imaging lens with a short total optical length while satisfying the required focal length.

Here, the above conditional expression has a positive value. That is, the lower limit value of the conditional expression (6) is larger than “0”. Further, in order to obtain these effects, the upper limit value of the conditional expression (6) is more preferably 1.15, further preferably 1.1, and even more preferably 1.0.

2. Imaging Device

Next, the imaging device according to the present invention will be described. The imaging device according to the present invention includes the above-described imaging lens according to the present invention and an image sensor which converts an optical image formed by the imaging lens into an electrical signal. Incidentally, it is preferable that the image sensor is provided on the image side of the optical system.

Here, the image sensor or the like is not particularly limited, and a solid-state image sensor such as a charge coupled device (CCD) sensor or a complementary metal oxide semiconductor (CMOS) sensor may also be used. The imaging device according to the present invention is suitable for an imaging device using these solid-state image sensors such as a digital camera and a video camera. Further, the imaging device can be applied to various imaging devices such as a single lens reflex camera, a mirrorless camera, a digital still camera, a surveillance camera, an in-vehicle camera, and a drone-mounted camera. Further, these imaging devices may be interchangeable lens type imaging devices, or may be lens-fixed imaging devices in which a lens is fixed to a housing.

In particular, the imaging lens is suitable or a so-called macro lens having a maximum imaging magnification of 0.5 times or more and thus is suitable for applications required to largely image a subject with the imaging device such as the single lens reflex camera and the mirrorless camera and an industrial imaging device.

Next, the present invention will be specifically described with reference to embodiments. However, the present invention is not limited to the following embodiments.

### FIRST EMBODIMENT

(1) Optical Configuration

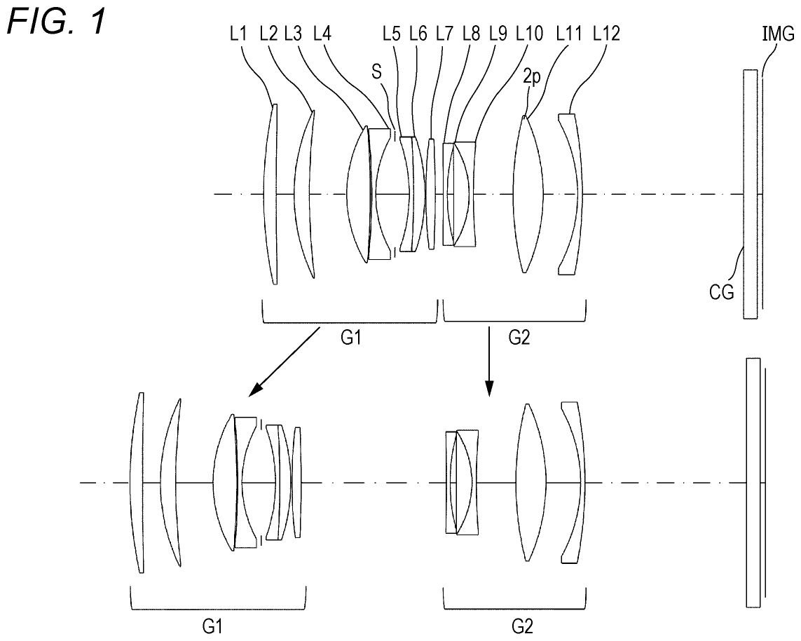

FIG. 1 is a lens cross-sectional view (upper row) illustrating a lens configuration of an imaging lens of a first embodiment according to the present invention during infinity focusing and a lens cross-sectional view (lower row) illustrating a lens configuration during focusing on a short-distance subject. The imaging lens is configured by an object side group G1 having positive refractive power and an image side Group G2 having negative refractive power in order from the object side, and when focusing from an infinity object to a short-distance object, the object side group G1 is moved to the object side along the optical axis with the image side group fixed in the optical axis direction.

The object side group G1 includes, in order from the object side, a positive meniscus lens L1 having a convex surface facing the object side, a positive meniscus lens L2 having a convex surface facing the object side, a biconvex lens L3, a biconcave lens L4, an aperture stop 3, a cemented lens in which a negative meniscus lens L5 having a concave surface facing the object side and a positive meniscus lens L6 having a concave surface facing the object side are cemented, and a biconvex lens L7.

The image side Group G2 includes, in order from the object side, a biconcave lens 18, a cemented lens in which a positive meniscus lens L9 having a concave surface facing the object side and a negative meniscus lens L10 having a concave surface facing the object side are cemented, a biconvex lens L11, and a negative meniscus lens L12 having a concave surface facing the object side. Here, the subgroup 2n is configured by the biconcave lens 18 and the cemented lens in which the positive meniscus lens L9 and the negative meniscus lens L10 are cemented, the subgroup 2p is configured by the biconvex lens L11, and the subgroup 2nb is configured by the negative meniscus lens 112.

Incidentally, in FIG. 1, “IMG” is an image plane, and specifically, illustrates an imaging surface of a solid-state image sensor such as a CCD sensor or a CMOS sensor, a film surface of a silver halide film, or the like. Further, a cover glass CC or the like is provided on the object side of the IP. Since this point is the same in the cross-sectional views of each lens shown in other embodiments, the description thereof will be omitted below.

(2) Numerical Embodiment

Next, a numerical embodiment to which a specific numerical value of the imaging lens is applied will be described. Herein, the surface data of the imaging lens, specifications, variable interval at the time of focusing, and focal length of each lens group are described below. In the table showing the surface data, “No.” indicates the order of the lens surfaces counted from the object side (plane number), “R” indicates the curvature radius of the lens surface, “D” indicates the interval on the optical axis of the lens surface, “Nd” indicates the refractive index for the d line (wavelength λ=587.6 nm), and “ABV” indicates the Abbe number for the d line. Further, in the “No.” column, the “s” displayed in the column next to the plane number indicates the aperture stop. Further, displaying “Doo” (D14 in this embodiment) in the “D” column indicates that the interval is variable during focusing. Incidentally, in each table shown below, all units of length are “mm” and all unit of angle of view are “º”. Further, in each table, “INF” indicates infinity, and “0.0000” in the column of the curvature radius indicates a plane.

In the table showing the specifications, “f” indicates the focal length of the imaging lens, “Fno” indicates an F number, “ω” indicates the half angle of view, “Y” indicates an image height, “BF” indicates a back focus, and “TL” indicates a total optical length. However, the values in the table include the cover glass (Nd 1.5168) having a thickness of 2.5 mm, and the same applies to the back focus shown in other embodiments.

In the table showing the variable interval during focusing, f indicates the focal length of the imaging lens during infinity focusing or focusing on the closest subject and indicates the variable interval at that time. Further, in the table showing the focal length of each lens group, the lens surface included in each lens group and the focal length of each lens group are shown.

Further, the values of each conditional expression. (1) to (6) are shown in Table 1 (described later). Since these matters related to the table are the same in each table shown in other embodiments, the description thereof will be omitted below.

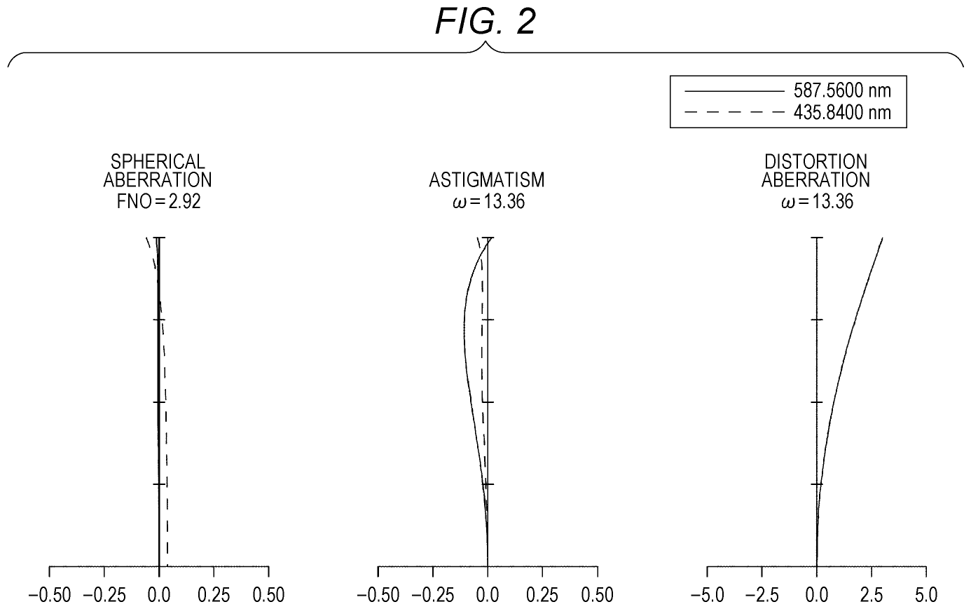

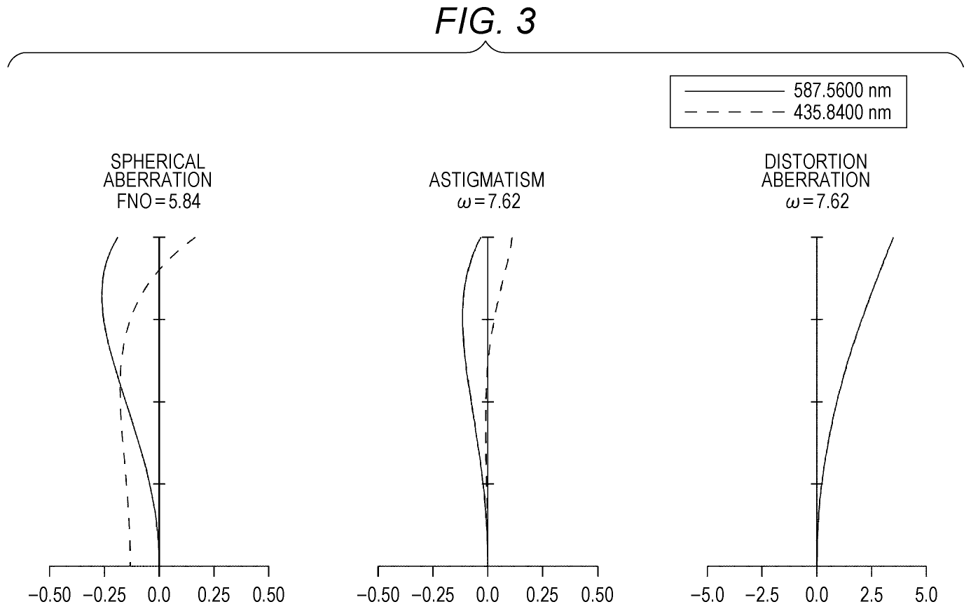

FIGS. 2 and 3 illustrate longitudinal aberration diagrams of the imaging lens during infinity focusing and focusing on the closest subject. In each longitudinal aberration diagram, spherical aberration, astigmatism, and distortion aberration are shown in order from the left when facing the drawing. In the diagram showing spherical aberration, a vertical axis indicates a ratio to the open F number, and a horizontal axis is defocused to indicate a spherical aberration at a d line (wavelength λ=507.56 nm) by a solid line and indicate a spherical aberration at a g line (wavelength λ=435.84 nm; by a dotted line. In the drawing showing astigmatism, a vertical axis indicates the half angle of view (ω), and a horizontal axis is defocused to indicate a sagittal image plane with respect to the d line by a solid line and indicate a meridional image plane with respect to the d line by a dotted line. In the drawing showing distortion aberration, a vertical axis is the half angle of view (ω), and the horizontal axis indicates distortion aberration with %. Since these matters related to each drawing are the same also in the longitudinal aberration diagrams shown in other embodiments, the description thereof will be omitted below.

(Surface data)

| No. | R | D | Nd | ABV |
|---|---|---|---|---|
| 1 | 77.8101 | 2.3000 | 1.75500 | 52.32 |
| 2 | 826.5154 | 3.2733 | | |
| 3 | 35.2201 | 2.8000 | 1.49700 | 81.61 |
| 4 | 122.5718 | 6.8269 | | |
| 5 | 24.4138 | 4.3000 | 1.49700 | 81.61 |
| 6 | −150.8795 | 0.2000 | | |
| 7 | −134.5344 | 0.8000 | 1.68893 | 31.07 |
| 8 | 21.5611 | 3.4868 | | |
| 9s | 0.0000 | 2.6398 | | |
| 10 | −29.8925 | 0.8000 | 1.68893 | 31.07 |
| 11 | −160.5872 | 2.0000 | 1.83481 | 42.74 |
| 12 | −33.3806 | 0.2116 | | |
| 13 | 84.6389 | 1.7000 | 1.84666 | 23.78 |
| 14 | −204.2745 | D14 | | |
| 15 | −1077.1947 | 0.7000 | 1.87070 | 40.73 |
| 16 | 32.9377 | 1.2000 | | |
| 17 | −872.0807 | 2.8000 | 1.69895 | 30.13 |
| 18 | −17.3632 | 0.8000 | 1.74400 | 44.79 |
| 19 | 102.3151 | 7.1958 | | |
| 20 | 58.0106 | 5.5000 | 1.76200 | 40.10 |
| 21 | −34.3589 | 6.3412 | | |
| 22 | −27.8177 | 0.8000 | 1.84666 | 23.78 |
| 23 | −76.7222 | 29.5167 | | |
| 24 | 0.0000 | 2.5000 | 1.51680 | 64.20 |
| 25 | 0.0000 | 1.0000 | | |

(Specifications)

| | | |
|---|---|---|
| f | 88.500 | 51.569 |
| Fno | 2.9200 | 5.8400 |
| ω | 13.3561 | 7.6197 |
| Y | 21.633 | 21.633 |
| BF | 33.0167 | 33.0167 |
| TL | 91.192 | 116.192 |

(Variable interval (during focusing))

| | | |
|---|---|---|
| f | 88.500 | 51.569 |
| Photographing distance | INF | 243.833 |
| D14 | 1.500 | 26.500 |

(Focal length of each lens group)

| Group | Plane number | Focal length |
|---|---|---|
| G1 | 1-14 | 47.250 |
| G2 | 15-23 | −65.384 |

### SECOND EMBODIMENT

(1) Optical Configuration

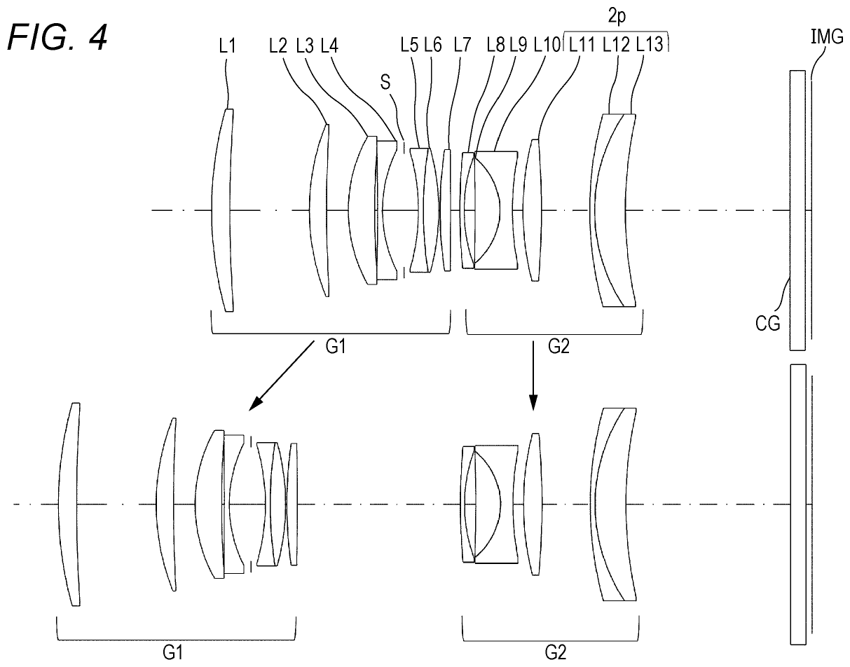

FIG. 4 is a lens cross-sectional view (upper row) illustrating a lens configuration of an imaging lens of a second embodiment according to the present invention during infinity focusing and a lens cross-sectional view (lower row) illustrating a lens configuration during focusing on a short-distance subject. The imaging lens is configured by an object side group G1 having positive refractive power and an image side group G2 having negative refractive power in order from the object side, and when focusing from an infinity object to a short-distance object, the object side group G1 is moved to the object side along the optical axis with the image side group fixed in the optical axis direction.

The object side group G1 includes, in order from the object side, a positive meniscus lens L1 having a convex surface facing the object side, a positive meniscus lens L2 having a convex surface facing the object side, a positive meniscus lens L3 having a convex surface facing the object side, a biconcave lens L4, an aperture stop S, a cemented lens in which a biconcave lens L5 and a biconvex lens L6 are cemented, and a biconvex lens L7.

The image side Group G2 includes, in order from the object side, a negative meniscus lens L8 having a convex surface facing the object side, a cemented lens in which a negative meniscus lens L9 having a concave surface facing the object side and a biconcave lens L10 are cemented, a biconvex lens L11, and a cemented lens in which a negative meniscus lens L12 having a convex surface facing the object side and a positive meniscus lens L13 having a convex surface facing the object side are cemented. Here, the subgroup 2n is configured by the negative meniscus lens L8 and the cemented lens in which the negative meniscus lens L9 and the biconcave lens L10 are cemented, and the subgroup 2p is configured by the biconvex lens L11 and the cemented lens in which the negative meniscus lens L12 and the positive meniscus lens L13 are cemented,

(2) Numerical Embodiment

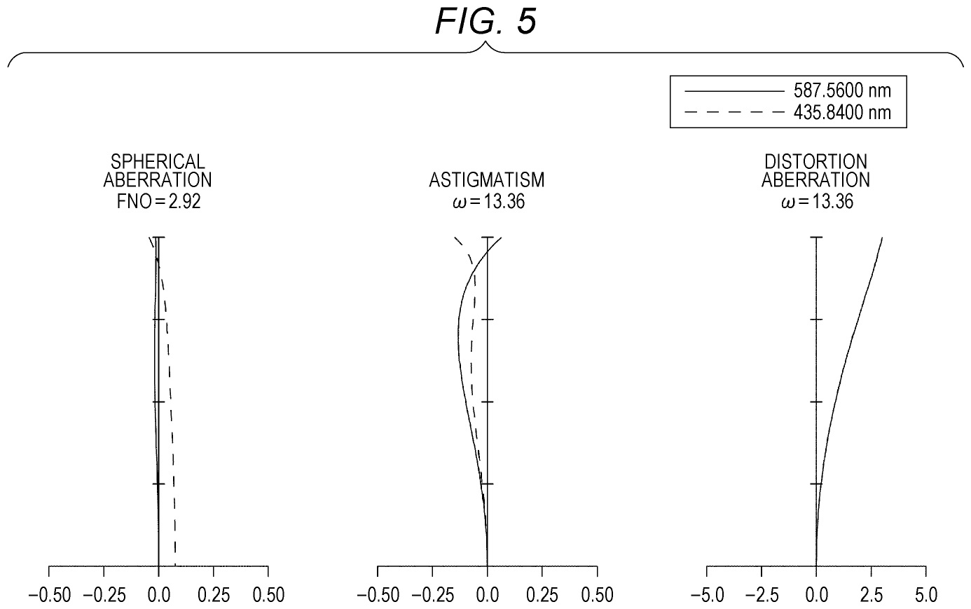

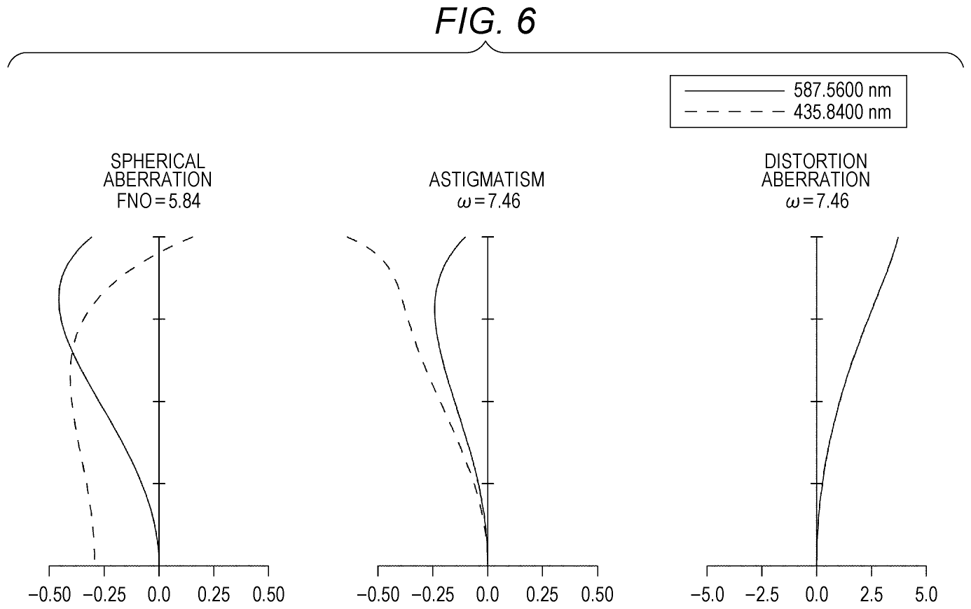

Next, a numerical embodiment to which a specific numerical value of the imaging lens is applied will be described. Herein, the surface data of the imaging lens, specifications, variable interval at the time of focusing, and focal length of each lens group are described below. Further, FIGS. 5 and 6 illustrate longitudinal aberration diagrams of the imaging lens during infinity focusing and focusing on the closest subject.

(Surface data)

| No. | R | D | Nd | ABV |
|---|---|---|---|---|
| 1 | 60.8926 | 2.9701 | 1.73362 | 49.63 |
| 2 | 228.9879 | 12.9237 | | |
| 3 | 37.6179 | 2.8000 | 1.49700 | 81.61 |
| 4 | 219.7840 | 3.5334 | | |
| 5 | 24.5092 | 4.3000 | 1.49700 | 81.61 |
| 6 | 145.7888 | 0.4629 | | |
| 7 | −559.1421 | 0.8000 | 1.68893 | 31.07 |
| 8 | 21.9803 | 3.5274 | | |
| 9s | 0.0000 | 2.3283 | | |
| 10 | −34.1118 | 0.8000 | 1.68893 | 31.07 |
| 11 | 64.7032 | 2.5000 | 1.83481 | 42.74 |
| 12 | −37.3727 | 0.2000 | | |
| 13 | 67.8117 | 1.7000 | 1.84666 | 23.78 |
| 14 | −689.1023 | D14 | | |
| 15 | 97.8652 | 0.7000 | 1.87070 | 40.73 |
| 16 | 25.4233 | 1.7985 | | |
| 17 | −314.3134 | 4.0000 | 1.73753 | 43.28 |
| 18 | −11.1169 | 2.0000 | 1.73180 | 54.29 |
| 19 | 45.9584 | 1.7238 | | |
| 20 | 45.8041 | 3.0000 | 1.66367 | 56.03 |
| 21 | −136.1350 | 7.8645 | | |
| 22 | 57.7644 | 0.8000 | 1.59282 | 68.62 |
| 23 | 28.0170 | 5.0000 | 1.72916 | 54.67 |
| 24 | 69.0619 | 26.7670 | | |
| 25 | 0.0000 | 2.5000 | 1.51680 | 64.20 |
| 26 | 0.0000 | 1.0000 | | |

(Specifications)

| | | |
|---|---|---|
| f | 88.5002 | 52.0971 |
| Fno | 2.9200 | 5.8400 |
| ω | 13.3585 | 7.4574 |
| Y | 21.633 | 21.633 |
| BF | 30.2670 | 30.2670 |
| TL | 97.500 | 122.500 |

(Variable interval (during focusing))

| | | |
|---|---|---|
| f | 88.5002 | 52.0971 |
| Photographing distance | INF | 239.131 |
| D14 | 1.5000 | 26.5000 |

(Focal length of each lens group)

| Group | Plane number | Focal length |
|---|---|---|
| G1 | 1-14 | 47.1962 |
| G2 | 15-23 | −67.0890 |

### THIRD EMBODIMENT

(1) Optical Configuration

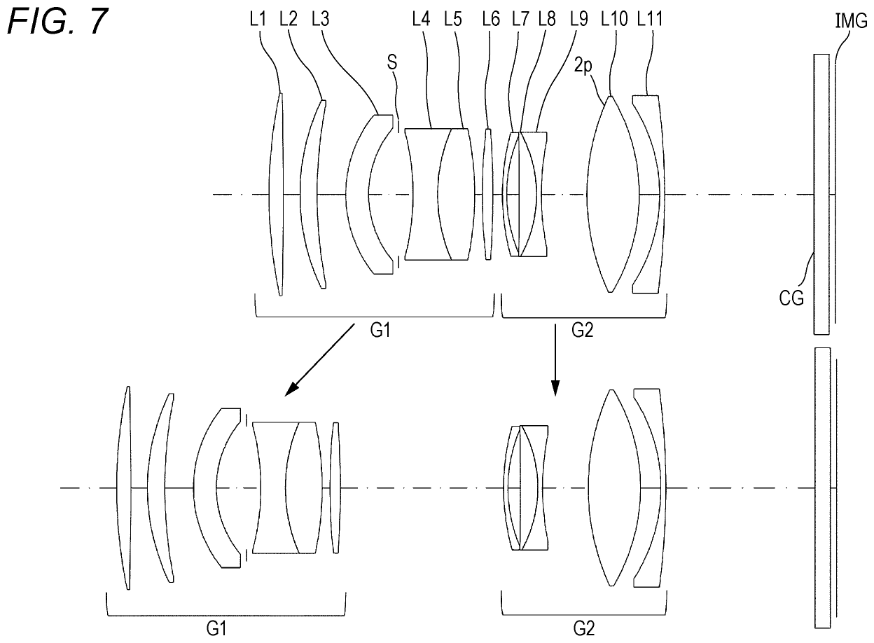

FIG. 7 is a lens cross-sectional view (upper row) illustrating a lens configuration of an imaging lens of a third embodiment according to the present invention during infinity focusing and a lens cross-sectional view (lower row) illustrating a lens configuration during focusing on a short-distance subject. The imaging lens is configured by an object side group G1 having positive refractive power and an image side group G2 having negative refractive power in order from the object side, and when focusing from an infinity object to a short-distance object, the object side group G1 is moved to the object side along the optical axis with the image side group fixed in the optical axis direction.

The object side group G1 includes, in order from the object side, a biconvex lens L1, a positive meniscus lens L2 having a convex surface facing the object side, a positive meniscus lens L3 having a convex surface facing the object side, an aperture stop S, a cemented lens in which a biconcave lens L4 and a biconvex lens L5 are cemented, and a biconvex lens L6.

The image side group G2 includes, in order from the object side, a negative meniscus lens L7 having a convex surface facing the object side, a cemented lens in which a positive meniscus lens L8 having a concave surface facing the object side and a biconcave lens L9 are cemented, a biconvex lens L10, and a negative meniscus lens L11 having a concave surface facing the object side. Here, the subgroup 2n is configured by the negative meniscus lens L7 and the cemented lens in which the positive meniscus lens L8 and the biconcave lens L9 are cemented, the subgroup 2p is configured by the biconvex lens L10, and the subgroup 2nb is configured by the negative meniscus lens L11.

(2) Numerical Embodiment

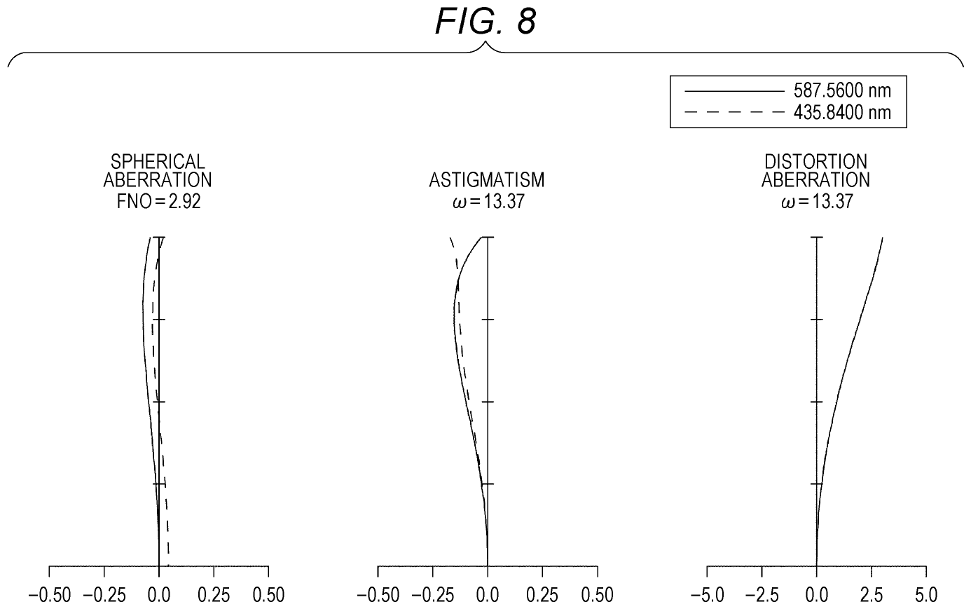

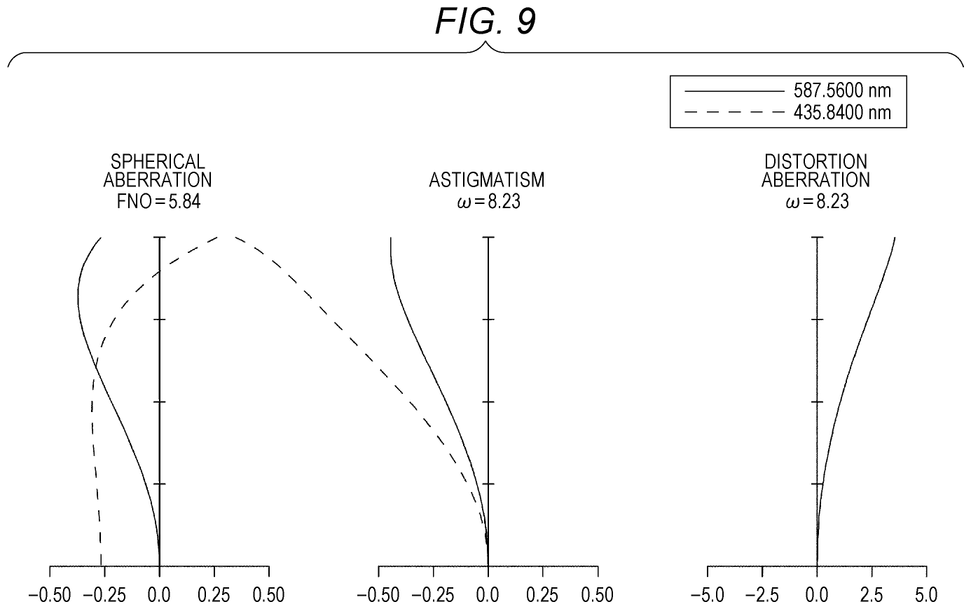

Next, a numerical embodiment to which a specific numerical value of the imaging lens is applied will be described. Herein, the surface data of the imaging lens, specifications, variable interval at the time of focusing, and focal length of each lens group are described below. Further, FIGS. 8 and 9 illustrate longitudinal aberration diagrams of the imaging lens during infinity focusing and focusing on the closest subject.

(Surface data)

| No. | R | D | Nd | ABV |
|---|---|---|---|---|
| 1 | 79.5668 | 2.3000 | 1.72916 | 54.67 |
| 2 | −768.3282 | 2.7230 | | |
| 3 | 35.2038 | 2.8000 | 1.51333 | 77.97 |
| 4 | 75.9852 | 4.6583 | | |
| 5 | 20.6253 | 3.7207 | 1.71460 | 27.96 |
| 6 | 16.8042 | 4.8998 | | |
| 7s | 0.0000 | 2.3391 | | |
| 8 | −39.5310 | 4.0000 | 1.77695 | 25.20 |
| 9 | 26.3186 | 6.0000 | 1.76377 | 50.23 |
| 10 | −50.8755 | 1.2562 | | |
| 11 | 95.7470 | 1.7000 | 1.92286 | 20.88 |
| 12 | −155.6100 | D12 | | |
| 13 | 37.6220 | 0.7000 | 1.90851 | 22.44 |
| 14 | 24.2915 | 2.0536 | | |
| 15 | −367.4207 | 2.8000 | 1.75467 | 25.89 |
| 16 | −21.0160 | 0.8000 | 1.79552 | 47.02 |
| 17 | 44.9865 | 7.4186 | | |
| 18 | 37.9897 | 8.5018 | 1.62643 | 46.01 |
| 19 | −31.0758 | 3.3254 | | |
| 20 | −26.8614 | 0.8000 | 1.85993 | 42.16 |
| 21 | −122.9274 | 24.2833 | | |
| 22 | 0.0000 | 2.5000 | 1.51680 | 64.20 |
| 23 | 0.0000 | 1.0000 | | |

(Specifications)

| | | |
|---|---|---|
| f | 88.5000 | 46.3116 |
| Fno | 2.9200 | 5.8400 |
| ω | 13.3676 | 8.2374 |
| Y | 21.633 | 21.633 |
| BF | 27.7833 | 27.7833 |
| TL | 92.0798 | 117.0798 |

(Variable interval (during focusing))

| | | |
|---|---|---|
| f | 88.5000 | 46.3116 |
| Photographing distance | INF | 235.320 |
| D12 | 1.5000 | 26.5000 |

(Focal length of each lens group)

| Group | Plane number | Focal length |
|---|---|---|
| G1 | 1-12 | 47.1635 |
| G2 | 13-21 | −51.4961 |

### FOURTH EMBODIMENT

(1) Optical Configuration

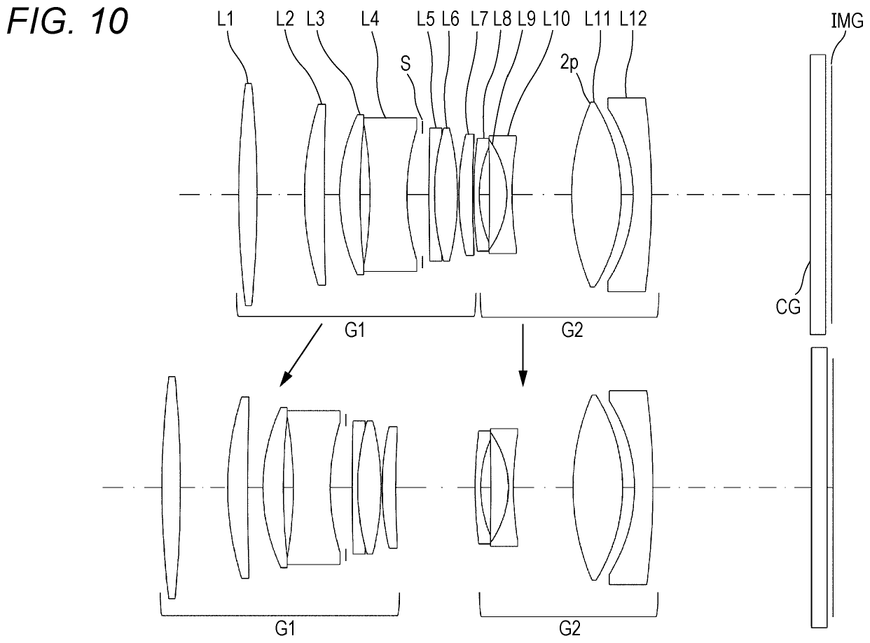

FIG. 10 is a lens cross-sectional view (upper row) illustrating a lens configuration of an imaging lens of a fourth embodiment according to the present invention during infinity focusing and a lens cross-sectional view (lower row) illustrating a lens configuration during focusing on a short-distance subject. The imaging lens is configured by an object side group G1 having positive refractive power and an image side group G2 having negative refractive power in order from the object side, and when focusing from an infinity object to a short-distance object, the object side group G1 is moved to the object side along the optical axis with the image side group fixed in the optical axis direction.

The object side group G1 includes, in order from the object side, a biconvex lens L1, a positive meniscus lens L2 having a convex surface facing the object side, a positive meniscus lens L3 having a convex surface facing the object side, a biconcave lens L4, an aperture stop S, a cemented lens in which a negative meniscus lens L5 having a convex surface facing the object side and a biconvex lens L6 are cemented, and a biconvex lens L7.

The image side group G2 includes, in order from the object side, a negative meniscus lens L8 having a convex surface facing the object side, a cemented lens in which a positive meniscus lens L9 having a concave surface facing the object side and a biconcave lens L10 are cemented, a biconvex lens L11, and a negative meniscus lens L12 having a concave surface facing the object side. Here, the subgroup 2n is configured by the negative meniscus lens L8 and the cemented lens in which the positive meniscus lens L9 and the biconcave lens L10 are cemented, the subgroup 2p is configured by the biconvex lens L11, and the subgroup 2nb is configured by the negative meniscus lens L12.

(2) Numerical Embodiment

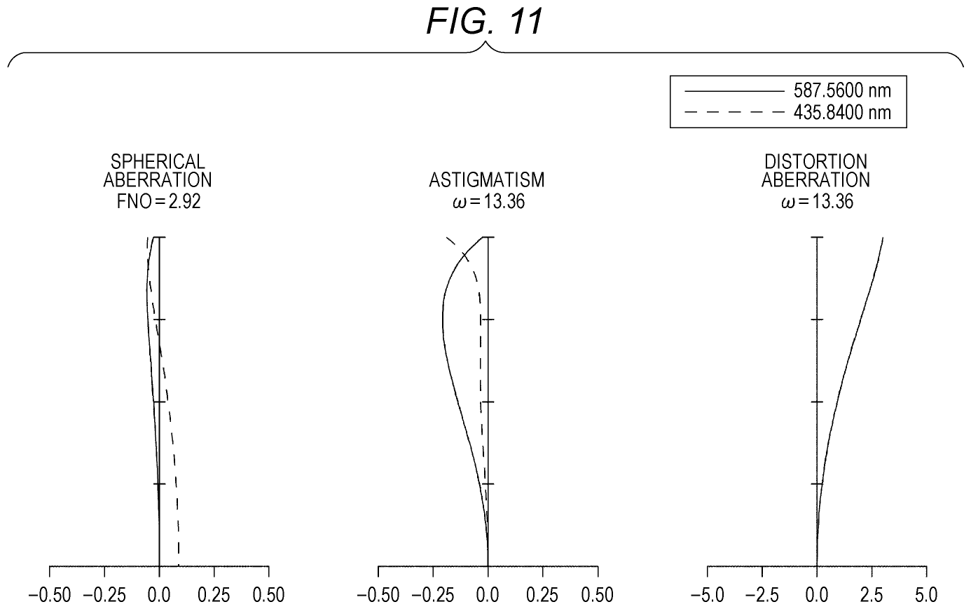

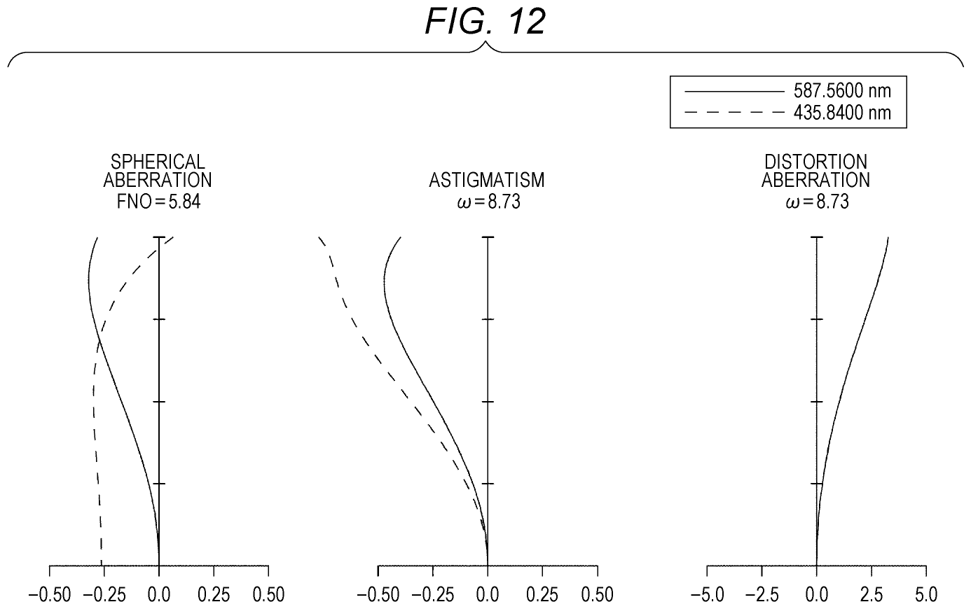

Next, a numerical embodiment to which a specific numerical value of the imaging lens is applied will be described. Herein, the surface data of the imaging lens, specifications, variable interval at the time of focusing, and focal length of each lens group are described below. Further, FIGS. 11 and 12 illustrate longitudinal aberration diagrams of the imaging lens during infinity focusing and focusing on the closest subject.

(Surface Data)

| No. | R | D | Nd | ABV |
|---|---|---|---|---|
| 1 | 149.0856 | 3.0000 | 1.76651 | 42.85 |
| 2 | −183.2809 | 7.6902 | | |
| 3 | 49.0744 | 3.2589 | 1.51022 | 78.62 |
| 4 | 531.6703 | 2.4814 | | |
| 5 | 30.6525 | 3.3290 | 1.50963 | 78.74 |
| 6 | 108.3925 | 1.6146 | | |
| 7 | −66.4160 | 6.0000 | 1.69696 | 29.53 |
| 8 | 35.6394 | 2.5512 | | |
| 9s | 0.0000 | 1.0363 | | |
| 10 | 448.5672 | 0.9000 | 1.75384 | 25.97 |
| 11 | 39.9989 | 3.7743 | 1.81556 | 45.31 |
| 12 | −44.5238 | 0.2000 | | |
| 13 | 44.7443 | 2.2001 | 1.88300 | 40.80 |
| 14 | 175.8198 | D14 | | |
| 15 | 72.4697 | 0.9000 | 1.88300 | 40.80 |
| 16 | 19.8985 | 1.6812 | | |
| 17 | −275.8396 | 2.8000 | 1.82545 | 23.26 |
| 18 | −15.4491 | 0.8000 | 1.81785 | 36.43 |
| 19 | 54.9325 | 9.6957 | | |
| 20 | 38.1761 | 8.0666 | 1.64730 | 33.13 |
| 21 | −28.1975 | 1.9381 | | |
| 22 | −26.1613 | 3.0000 | 1.91391 | 23.36 |
| 23 | −123.1916 | 25.8069 | | |
| 24 | 0.0000 | 2.5000 | 1.51680 | 64.20 |
| 25 | 0.0000 | 1.0000 | | |

(Specifications)

| | | |
|---|---|---|
| f | 88.5002 | 43.9330 |
| Fno | 2.9200 | 5.8400 |
| ω | 13.3616 | 8.7255 |
| Y | 21.633 | 21.633 |
| BF | 29.3069 | 29.3069 |
| TL | 96.4244 | 109.1300 |

(Variable interval (during focusing))

| | | |
|---|---|---|
| f | 88.5002 | 43.9330 |
| Photographing distance | INF | 208.653 |
| D14 | 0.2000 | 12.9058 |

(Focal length of each lens group)

| Group | Plane number | Focal length |
|---|---|---|
| G1 | 1-14 | 33.6300 |
| G2 | 15-23 | −32.9609 |

### FIFTH EMBODIMENT

(1) Optical Configuration

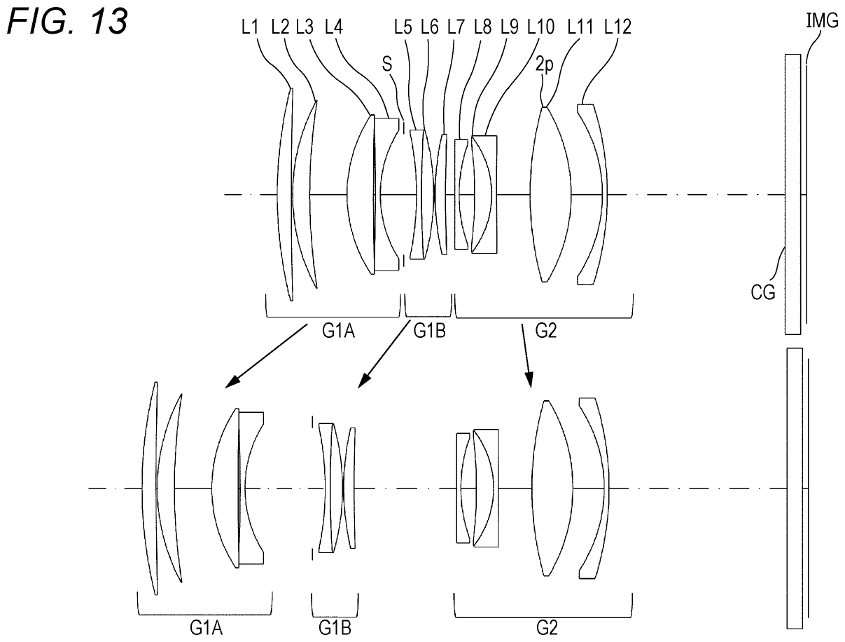

FIG. 13 is a lens cross-sectional view (upper row) illustrating a lens configuration of an imaging lens of a fifth embodiment according to the present invention during infinity focusing and a lens cross-sectional view (lower row) illustrating a lens configuration during focusing on a short-distance subject. The imaging lens is configured by an object side group G1 having positive refractive power and an image side group G2 having negative refractive power in order from the object side, and when focusing from an infinity object to a short-distance object, the object side group G1 is moved to the object side along the optical axis with the image side group fixed in the optical axis direction.

The object side group G1 is configured by a first A lens group G1A having positive refractive power and a first B lens group G1B having positive refractive power. The first A lens group G1A includes, in order from the object side, a positive meniscus lens L1 having a convex surface facing the object side, a positive meniscus lens L2 having a convex surface facing the object side, a positive meniscus lens L3 having a convex surface facing the object side, and a biconcave lens L4. The first B lens group G1B includes an aperture stop S, a cemented lens in which a biconcave lens L5 and a biconvex lens L6 are cemented, and a biconvex lens L7.

The image side group G2 includes, in order from the object side, a negative meniscus lens L8 having a convex surface facing the object side, a cemented lens in Which a positive meniscus lens L9 having a concave surface facing the object side and a biconcave lens L10 are cemented, a biconvex lens L11, and a negative meniscus lens L12 having a concave surface facing the object side. Here, the subgroup 2n is configured by the negative meniscus lens L8 and the cemented lens in which the positive meniscus lens L9 and the biconcave lens L10 are cemented, the subgroup 2p is configured by the biconvex lens L11, and the subgroup 2nb is configured by the negative meniscus lens 112.

(2) Numerical Embodiment

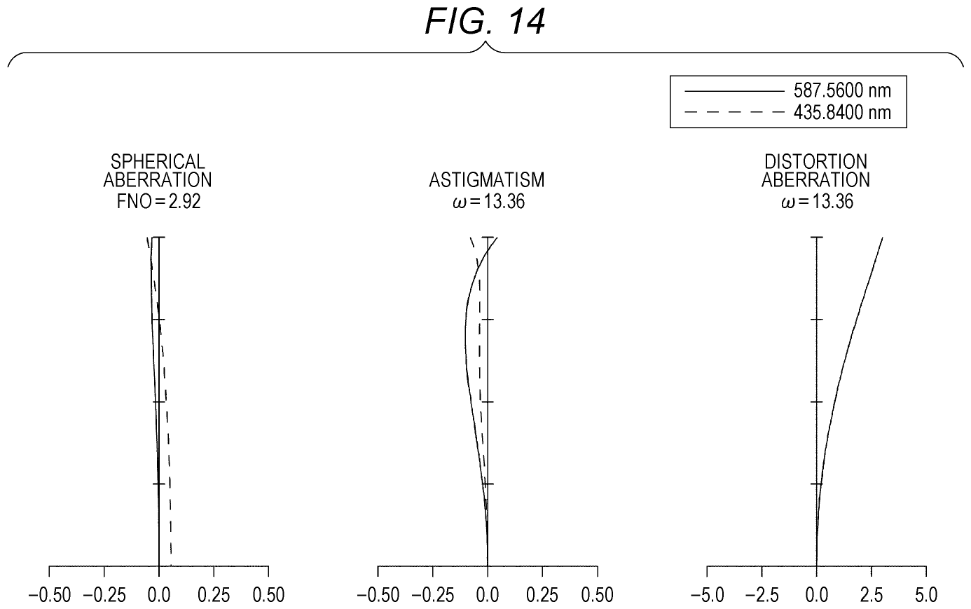

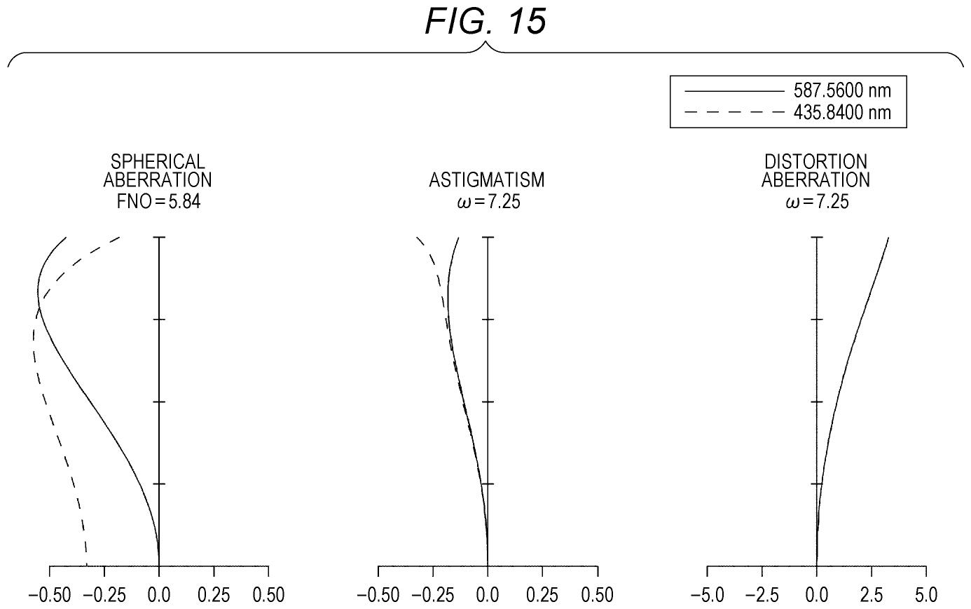

Next, a numerical embodiment to which a specific numerical value of the imaging lens is applied will be described. Herein, the surface data of the imaging lens, specifications, variable interval at the time of focusing, and foczl length of each lens group are described below. Further, FIGS. 14 and 15 illustrate longitudinal aberration diagrams of the imaging lens during infinity focusing and focusing on the closest subject.

(Surface data)

| No. | R | D | Nd | ABV |
|---|---|---|---|---|
| 1 | 70.2706 | 2.3000 | 1.78241 | 48.26 |
| 2 | 693.5698 | 0.2000 | | |
| 3 | 31.8788 | 2.8000 | 1.49700 | 81.61 |
| 4 | 97.7941 | 6.0730 | | |
| 5 | 23.3731 | 4.3000 | 1.49700 | 81.61 |
| 6 | 547.5231 | 0.3037 | | |
| 7 | −349.1291 | 0.8000 | 1.67464 | 35.67 |
| 8 | 19.6114 | D8 | | |
| 9s | 0.0000 | 2.0906 | | |
| 10 | −48.4278 | 0.8000 | 1.67528 | 30.63 |
| 11 | 158.2266 | 2.0000 | 1.78501 | 48.01 |
| 12 | −38.5110 | 0.2000 | | |
| 13 | 42.8307 | 1.7000 | 1.87007 | 41.55 |
| 14 | 263.7021 | D14 | | |
| 15 | 1985.5439 | 0.7000 | 1.89037 | 34.50 |
| 16 | 24.2845 | 2.5212 | | |
| 17 | −69.7349 | 2.8000 | 1.69988 | 28.87 |
| 18 | −15.3437 | 0.8000 | 1.77309 | 49.22 |
| 19 | 1097.6211 | 5.3936 | | |
| 20 | 52.9577 | 6.6727 | 1.68663 | 32.64 |
| 21 | −27.7385 | 5.0959 | | |
| 22 | −24.0253 | 0.8000 | 1.92178 | 21.15 |
| 23 | −47.9818 | 28.9495 | | |
| 24 | 0.0000 | 2.5000 | 1.51680 | 64.20 |
| 25 | 0.0000 | 1.0000 | | |

(Specifications)

| | | |
|---|---|---|
| f | 88.5000 | 48.8693 |
| Fno | 2.9200 | 5.8400 |
| ω | 13.3590 | 7.2500 |
| Y | 21.633 | 21.633 |
| BF | 32.4495 | 32.4495 |
| TL | 86.1213 | 108.4514 |

(Variable interval (during focusing))

| | | |
|---|---|---|
| f | 88.5002 | 43.9330 |
| Photographing distance | INF | 224.2161 |
| D8 | 3.8213 | 10.9951 |
| D14 | 1.5000 | 16.6560 |

(Focal length of each lens group)

| Group | Plane number | Focal length |
|---|---|---|
| G1A | 1-8 | 78.8060 |
| G1B | 9-14 | 39.9746 |
| G2 | 15-23 | −41.1246 |

TABLE 1

| | | First | Second | Third | Fourth | Fifth |
|---|---|---|---|---|---|---|
| | | embodiment | embodiment | embodiment | embodiment | embodiment |
| Conditional | f1/f | 0.533 | 0.533 | 0.533 | 0.380 | 0.420 |
| expression (1) | | | | | | |
| Conditional | f2p/f | 0.328 | 0.470 | 0.327 | 0.295 | 0.310 |
| expression (2) | | | | | | |
| Conditional | \|β\| | 1.000 | 1.000 | 1.000 | 1.000 | 1.000 |
| expression (3) | | | | | | |
| Conditional | Bf1/f | 0.307 | 0.292 | 0.302 | 0.210 | 0.236 |
| expression (4) | | | | | | |
| Conditional | BF/Y | 1.526 | 1.399 | 1.284 | 1.400 | 1.500 |
| expression (5) | | | | | | |
| Conditional | TL/f | 1.030 | 1.101 | 1.040 | 1.082 | 0.973 |
| expression (6) | | | | | | |

According to the present invention, it is possible to provide the imaging lens capable of imaging close to a subject and the imaging device which have high optical performance while achieving miniaturization and cost reduction.

What is claimed is:

1. An imaging lens which is configured by, in order from an object side, an object side group including at least one lens group and having positive refractive power as a whole and an image side group configured by one lens group and having negative refractive power, wherein
focusing is performed by moving the object side group in an optical axis direction,
a following conditional expression (1) is satisfied, and
the image side group includes a subgroup 2p satisfying a following conditional expression (2) and having positive refractive power:
0<f1/f<0.75 (1)
0<f2p/f<0.5 (2)
where
f is a focal length of the imaging lens during infinity focusing,
f1 is a focal length of the object side group, and
f2p is a focal length of the subgroup 2p.

2. The imaging lens according to claim 1, wherein
the imaging lens satisfies a following conditional expression:

|β|≥0.5 (3)
where
β is a paraxial imaging magnification of the imaging lens at a shortest imaging distance.

3. The imaging lens according to claim 1, wherein
the subgroup 2p is configured by a single lens element, and
the single lens element is configured by only one lens or only one cemented lens obtained by cementing a plurality of lenses.

4. The imaging lens according to claim 1, wherein
the imaging lens satisfies a following conditional expression:
0<Bf1/f<0.4 (4)
where
Bf1 is a distance on an optical axis from a most image side surface of the object side group to a focal position of the object side group.

5. The imaging lens according to claim 1, wherein
the image side group is fixed in the optical axis direction during focusing.

6. The imaging lens according to claim 1, wherein
an aperture stop is arranged in the object side group.

7. The imaging lens according to claim 6, wherein
each of lens surfaces adjacent to an object side and an image side of the aperture stop is a concave surface.

8. The imaging lens according to claim 6, wherein
at least one negative lens is arranged on the object side from the aperture stop.

9. The imaging lens according to claim 1, wherein
the object side group is configured by seven or less lenses.

10. The imaging lens according to claim 1, wherein
the imaging lens satisfies a following conditional expression:
0.3≤BF/Y≤1.7 (5)
where
BF is a back focus of the imaging lens when infinity focusing, and
Y is a maximum image height of the imaging lens.

11. The imaging lens according to claim 1, wherein
the imaging lens satisfies a following conditional expression:
TL/f≤1.2 (6)
where
TL is a total optical length of the imaging lens when infinity focusing.

12. An imaging device comprising:
the imaging lens according to claim 1; and
an image sensor which converts an optical image formed by the imaging lens into an electrical signal.
